(19) United States
(12) Patent Application Publication
(10) Pub. No.: US 2017/0191865 A1
(43) Pub. Date: Jul. 6, 2017

(54) A CONTROL UNIT AND A METHOD FOR CONTROLLING A VEHICLE COMPRISING A PLATFORM FOR CARRYING A LOAD.

(71) Applicant: VOLVO CONSTRUCTION EQUIPMENT AB, Eskilstuna (SE)

(72) Inventor: Roland KVIST, Braås (SE)

(73) Assignee: VOLVO CONSTRUCTION EQUIPMENT AB, Eskilstuna (SE)

(21) Appl. No.: 15/313,117

(22) PCT Filed: Jun. 17, 2014
(86) PCT No.: PCT/SE2014/000081

§ 371 Date: Nov. 22, 2016

(51) Int. Cl. G01G 19/08; B60P 1/28; F02N 11/08; B60P 1/04

(52) U.S. Cl. CPC G01G 19/08; B60P 1/045; B60P 1/283; F02N 11/0833; F02N 2200/08; F02N 2200/0802

(57) ABSTRACT

A control unit is provided for controlling a vehicle including a platform for carrying a load and an engine system for controlling an engine of the vehicle, wherein the control unit is configured to receive a signal, from at least one weight indication means of the vehicle, the signal being indicative of a weight of a load on the platform; compare the received indicated weight of the load on the platform with a predetermined threshold value. The control unit is further configured to provide an engine start-up signal to the engine system of the vehicle if the received indicated weight of the load on the platform is above the predetermined threshold value.

### BACKGROUND AND SUMMARY

The present invention relates to a control unit for controlling a vehicle comprising a platform for carrying a load and an engine system for controlling an engine of the vehicle. The invention also relates to a corresponding method for controlling a vehicle, a control system, a computer program and a computer readable medium. The invention is applicable on vehicles, in particularly working machines such as e.g. articulated haulers. However, although the invention will mainly be described in relation to an articulated hauler, the invention is of course also applicable for other type of vehicles, such as e.g. dump trucks or other trucks which are configured to convey various kinds of loads.

In connection with transportation of loads at e.g. construction sites or the like, working machines in the form of dump trucks, articulated haulers or the like are frequently used. In its simplest configuration, the machines are arranged to load a platform of the vehicle, or e.g. a dump body or container arranged on the platform of the vehicle, at a loading position of the construction site and drive to an unloading position of the construction site, located at a distance from the loading position, where it unloads the platform of the vehicle. At the unloading position, the loads are often taken care of in one way or the other. For example, at a quarry plant, large stone material is often freighted to an unloading position having a crusher for handling the load received from the working machines.

In cases where the loading of the platform continues for a sufficiently long time period, the driver of the working machine should turn off the engine in order to e.g. reduce fuel consumption of the vehicle. When the loading of the platform is completed, the driver of the vehicle starts the engine and takes off to the unloading position, or to another loading position.

However, starting the engine when the loading of the platform is completed involves a start-up phase of the engine before the working machines is able to leave the loading position. Hence, when loading is completed there is a time period before the vehicle is able to start its take off to the unloading position, which implies a reduction in productivity of the working machine.

U.S. Pat. No. 5,822,224 describes a solution to the above mentioned problem. More particularly, U.S. Pat. No. 5,822,224 describes a system in which a start permission signal is reported to an operator of the vehicle when it is time to start up the truck.

However, the system in U.S. Pat. No. 5,822,224 is still in need of further improvements, in terms of e.g. increased productivity of the vehicle,

It is desirable to provide a control unit which increases the productivity of a vehicle.

According to a first aspect of the invention, there is provided a control unit for controlling a vehicle comprising a platform for carrying a load and an engine system for controlling an engine of the vehicle, wherein the control unit is configured to receive a signal, from at least one weight indication means of the vehicle, the signal being indicative of a weight of a load on the platform; compare the received indicated weight of the load on the platform with a predetermined threshold value; wherein the control unit is further configured to provide an engine start-up signal to the engine system of the vehicle if the received indicated weight of the load on the platform is above the predetermined threshold value.

It should be readily understood that the engine start-up signal provided from the control unit to the engine system is configured to be automatically provided to the engine system. Accordingly, the operator of the vehicle, i.e. the driver of the vehicle, does not need to actively start-up the vehicle engine.

Furthermore, the wording “load on the platform” should in the following be understood to mean an external load which is provided to the platform of the vehicle during loading thereof. Hence, if a dump body or container is arranged on the platform, the “load on the platform” should include the weight of the container as well as the weight of the load provided into the container. However, the control unit may also be calibrated in such a way that it is only the weight of the load provided into the container that is included in the terminology “load on the platform”, and not the weight of the container itself.

Furthermore, the predetermined threshold value should be understood to be a value which can be set differently depending on e.g. the specific loading scenario, the size of the vehicle, or platform, provided with a load, the size of the vehicle, or bucket, providing load to the container, etc. Hence, the present invention should not be construed as limited to a specific and exact threshold value, but which instead can change depending on the loading situation.

Still further, the weight indication means should be understood as an arrangement of the vehicle which detects a load on the platform of the vehicle. More precisely, the weight indication means is arranged to measure/detect a weight of the load on the platform. The weight indication means may, for example, be a weight sensor arranged on the platform of the vehicle for sensing a load thereof. Other weight indication means are of course conceivable, such as an arrangement measuring/detecting a load on the platform by means of pressure measurements of hydraulic cylinders connected to the platform of the vehicle, etc.

The present invention is based on the insight that automatically start-up of the engine when loading of the platform is almost completed will increase the productivity of the vehicle since the vehicle will be able to take off rather immediately after completion of the loading process. Hereby, the engine of the vehicle is started automatically, without the need of manual control from a vehicle operator, at a suitable time period before final completion of the loading. Hence, the driver of the vehicle does not need to take any action of his own, or does not have to judge whether it is suitable to start the engine or not, for starting up the engine. An advantage is thus that unnecessary delays due to time consuming start-ups are prevented. Also, another advantage is that the fuel consumption of the vehicle can be reduced since, compared to a situation where the driver is manually starting the engine, optimization of engine start up can be made such that the engine is started at a relatively optimum time period before completion of the loading at the loading position.

According to an example embodiment, the control unit may be further configured to determine if the vehicle is in a load receiving mode; and to provide the engine startup signal to the engine system only if the vehicle is in the load receiving mode.

The load receiving mode should be understood as a state of the vehicle where it is arranged to receive load. Examples of how to determine if the vehicle is in the load receiving mode is given below and can vary depending on e.g. the specific vehicle in question or other environmental prerequisites etc. Hence, when the vehicle is in the load receiving mode, the vehicle is standing still and load can hence be provided to e.g. a dump body or container arranged on the vehicle platform.

The advantage of only providing the start-up signal to the engine system when the vehicle is in the load receiving mode is that the vehicle engine will only be started up when it is desired to do so. For example, if the vehicle after loading is driving to an unloading position and stops the vehicle to take a break and shuts off the vehicle engine, then the vehicle engine is not started up since the vehicle is not considered to be in the load receiving mode even though the weight of the load on the platform is above the predetermined threshold value. Further, the vehicle can be provided with an automatic engine shut off functionality when the vehicle is standing still at e.g. a red light of a traffic signal or in a traffic jam. In such situations it may be important that the vehicle engine is not automatically started up since this is not desired.

According to an example embodiment, the vehicle may be in the load receiving mode if the signal received from the at least one weight indication means indicates an increase of the load on the platform within a predetermined time period.

Hereby, it is determined that the vehicle is in the load receiving mode when the sensor detects that the weight of the platform is steadily increasing over a specific time period. If the load is provided from e.g. a wheel loader, it may be determined that the vehicle is in the load receiving mode if the weight is increasing at the approximate time intervals it takes for the wheel loader to provide dumps of load to the vehicle. An advantage is that already available weight indication means of the platform may be utilized for determination of whether the vehicle is in the load receiving mode or not. Also, determining that the vehicle is in the load receiving mode by means of the increasing weight of the load on the platform is advantageous since it clearly discriminates between a loading state of the vehicle and a state where the vehicle engine is merely shut off for other reasons than loading.

According to an example embodiment, the control unit may be further configured to receive a signal from a load starting actuator, indicating that the vehicle is in the load receiving mode.

An advantage is that the vehicle operator actively indicates that the vehicle is in the load receiving mode, i.e. the vehicle is about to receive a load. The load starting actuator may be a maneuvering organ arranged within the cabin of the vehicle and connected to the control unit. Hereby, activating the maneuvering organ provides an indication to the control unit that the vehicle operator has decided that loading will begin. The maneuvering organ may be arranged in such a way that activation thereof sends a signal to the control unit. The control unit may then activate the brakes of the vehicle and bring the gear box to its neutral position.

According to an example embodiment, the control unit may be further configured to receive a signal from a vehicle stand-still determination means indicative of a vehicle stand-still configuration; and to provide the engine start-up signal to the engine system only if the received signal from the vehicle stand-still determination means indicates that the vehicle is arranged in a stand-still configuration.

An advantage is that the vehicle engine will only be started up if the vehicle is arranged in such a way that it will not be able to move due to the engine start-up. Hence, a safety factor is provided to the control unit. The stand-still configuration of the vehicle may be based on the determination that e.g. the gear box is in its neutral position, which will be further described below, the brakes of the vehicle, either the parking brakes or the service brakes, are applied, i.e. activated, etc.

According to an example embodiment, the control unit may be further configured to receive a signal from a driving seat sensor configured to sense the presence of a driver in the vehicle driving seat; and to provide the engine start-up signal to the engine system only if the received signal from the driving seat sensor indicates that the driver is sitting in the driving seat of the vehicle.

Hereby, the vehicle engine will only be started-up if the driver of the vehicle is sitting in the driving seat. Hereby, a further safety aspect is provided such that the vehicle engine will not be started under uncontrolled situations. Other means than weight sensors in the driving seat may be provided to determine that the driver is sitting in the driving seat, such as a camera, eye detection arrangements, body heat scanning arrangements, etc. Hence, according to an example embodiment, the control unit provides the engine start-up signal to the engine system only if a passenger detection means determines that a passenger is sitting in the vehicle, preferably in the driving seat of the vehicle.

According to an example embodiment, the control unit may be further configured to receive a signal indicative of a current gear position of a gearbox of the vehicle; and to provide the engine start-up signal to the engine system only if the gearbox of the vehicle is arranged in neutral gear position.

As described above, a further safety aspect is provided to the control unit by means of only starting the vehicle engine if the gear box is in neutral position.

According to an example embodiment, the control unit may be further configured to determine if the vehicle is in a load receiving mode; and to provide an engine shutdown signal to the engine system if the vehicle engine is running and the received indicated weight of the load on the platform is below the predetermined threshold value.

Hereby, if the vehicle is in the load receiving mode and the engine is still running, the control unit may actively, and automatically, shut off the vehicle engine. Hereby, a reduction of the fuel consumption is provided and hence the exhaust gas from the vehicle is reduced. Furthermore, if the vehicle engine has been automatically shut-off, this is an indication that the vehicle engine should again be started up once the weight is above the predetermined threshold value.

According to an example embodiment, the predetermined threshold value may be configured to be manually set before the platform receives the load.

An advantage is that an increased flexibility in determining when to start up the engine is provided. Hence, if it is determined that e.g. three loads from the bucket of a wheel loader will provide a full container, it may be determined before the loading process begins, that the predetermined threshold value is corresponding to the weight of two loads from the bucket, such that the engine is initiating start-up after receiving the second load and is completely started-up when receiving the third and final load from the bucket of the wheel loader.

According to an example embodiment, the predetermined threshold value may be a first predetermined threshold value, wherein the control unit comprises further predetermined threshold values for additional loading of the platform.

Hereby, a first threshold value may be set at a first loading position. When the vehicle thereafter is driving to the second loading position to receive further load, a second, and higher threshold value, is set such that the start-up signal is provided to the engine system when the second threshold value is reached. The vehicle may then e.g. drive to a still further loading position or to an unloading position. An advantage is that the control unit is provided with an increased flexibility for situations where the vehicle will receive load from more than one loading position.

According to a second aspect of the present invention, there is provided a method for controlling a vehicle comprising a platform for carrying a load and an engine system for controlling an engine of the vehicle, the method comprising the steps of: receiving a signal, from at least one weight indication means of the vehicle, indicative of a weight of a load on the platform; comparing the received indicated weight of the load on the platform with a predetermined threshold value; wherein the method further comprising the step of: providing, from a control unit, an engine start-up signal to the engine system of the vehicle if the received indicated weight of the load on the platform is above the predetermined threshold value.

Effects and features of this second aspect of the present invention are largely analogous to those described above in relation to the first aspect of the present invention.

According to a third aspect of the present invention there is provided a control system for controlling a vehicle comprising a platform for carrying a load, the control system comprising a weight indication means for detecting a weight of a load on the platform, an engine system for controlling an engine of the vehicle, and a control unit; wherein the control unit is configured to receive a signal from the weight indication means, the signal being indicative of the detected weight of the load on the platform; compare the received indicated weight of the load on the platform with a predetermined threshold value; wherein the control unit is further configured to provide an engine start-up signal to the engine system if the received indicated weight of the load on the platform is above the predetermined threshold value.

Effects and features of this third aspect of the present invention are largely analogous to those described above in relation to the first aspect of the present invention.

According to a fourth aspect of the present invention, there is provided a computer program comprising program code means for performing the steps of the above described method when the program is run on a computer.

According to a fifth aspect of the present invention, there is provided a computer readable medium carrying a computer program comprising program code means for performing the steps of the above described method when the program product is run on a computer.

According to a sixth aspect of the present invention, there is provided a vehicle comprising a platform for carrying a load and an engine system for controlling an engine of the vehicle, wherein the vehicle is provided with a control unit according to the above described first aspect of the present invention.

Effects and features of the fourth, fifth and sixth aspects of the present invention are largely analogous to those described above in relation to the first aspect of the present invention.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

The above, as well as additional features and advantages of the present invention, will be better understood through the following illustrative and non-limiting detailed description of exemplary embodiments of the present invention, wherein:

FIG. 1 is a side view of a working machine provided with a control unit according to an example embodiment of the present invention;

FIG. 2 illustrates a control system arrangement having a control unit according to an example embodiment of the present invention;

FIG. 3 shows a flow chart of a method according to an example embodiment of the present invention; and

FIG. 4 illustrates a loading scenario at a working site where the vehicle is provided with the inventive control unit according to an example embodiment of the present invention.

### DETAIL DESCRIPTION

The present invention will now be described more fully hereinafter with reference to the accompanying drawings, in which exemplary embodiments of the invention are shown. The invention may, however, be embodied in many different forms and should not be construed as limited to the embodiments set forth herein; rather, these embodiments are provided for thoroughness and completeness. Like reference character refer to like elements throughout the description.

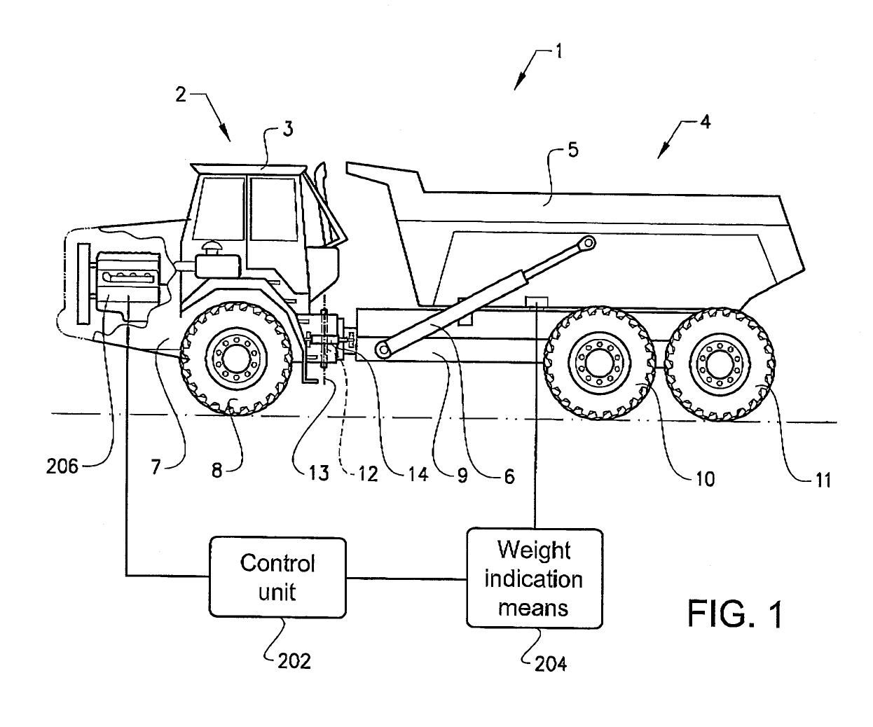

FIG. 1 is a side view of a working machine 1 in the form of an articulated hauler having a front section 2 with a cab 3 for a driver and a rear section 4 with a platform having a dump body or container 5 arranged thereon, for receiving load. The container is preferably pivotally connected to the rear section and tiltable by means of a pair of tilting cylinders 6, for example hydraulic cylinders. The front section has a front frame 7 and a pair of wheels 8 suspended from the front frame 7. The rear section 4 has a rear frame 9 and two pair of wheels 10, 11 suspended from the rear frame 9. The working machine is frame-steered, i.e. there is a pivot joint 12 connecting the front section 2 and the rear section 4 of the working machine 1. The front section and the rear section are pivotally connected to each other for pivoting around a substantially vertical pivot axis 13.

The working machine preferably comprises a hydraulic system having two hydraulic cylinders 14, steering cylinders, arranged on opposite sides of the working machine for turning the working machine by means of relative movement of the front section 2 and the rear section 4. The hydraulic cylinders can, however, be replaced by any other linear actuator for steering the machine, such as an electromechanical linear actuator.

The working machine can further comprise a second pivot joint connecting the front section and the rear section of the working machine for allowing the front section and the rear section to pivot relative to each other about a substantially horizontal pivot axis extending in the longitudinal direction of the working machine.

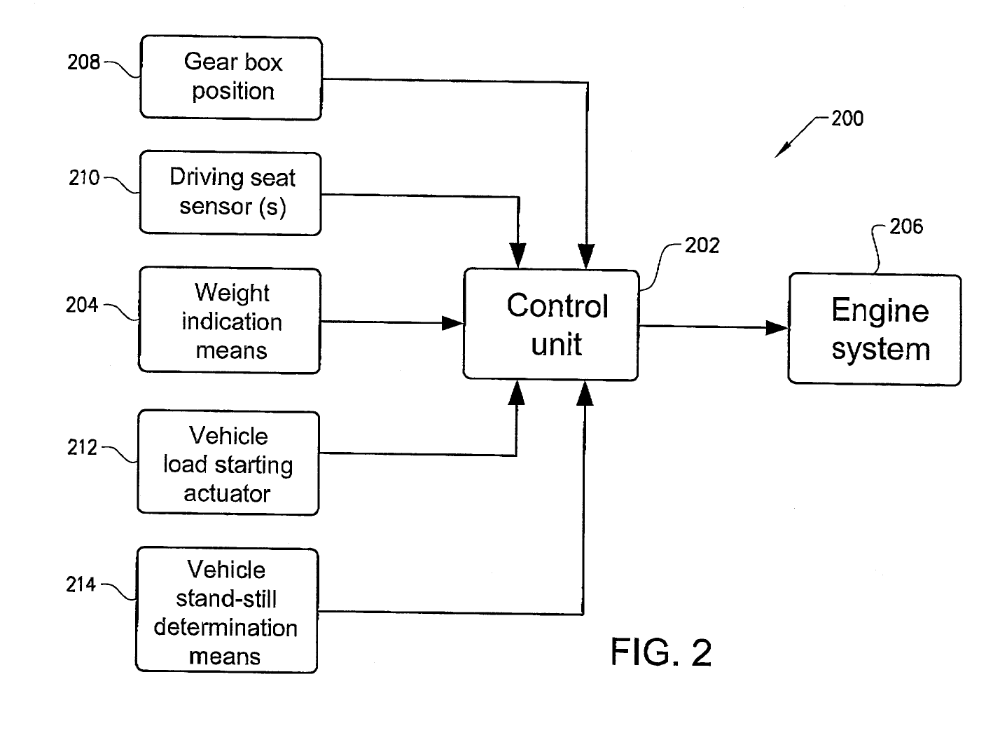

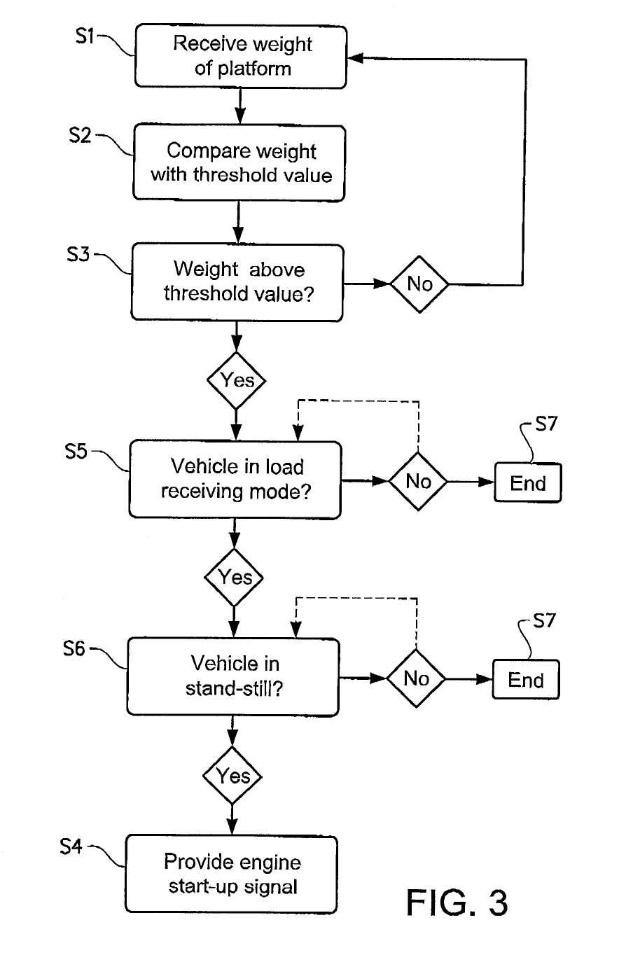

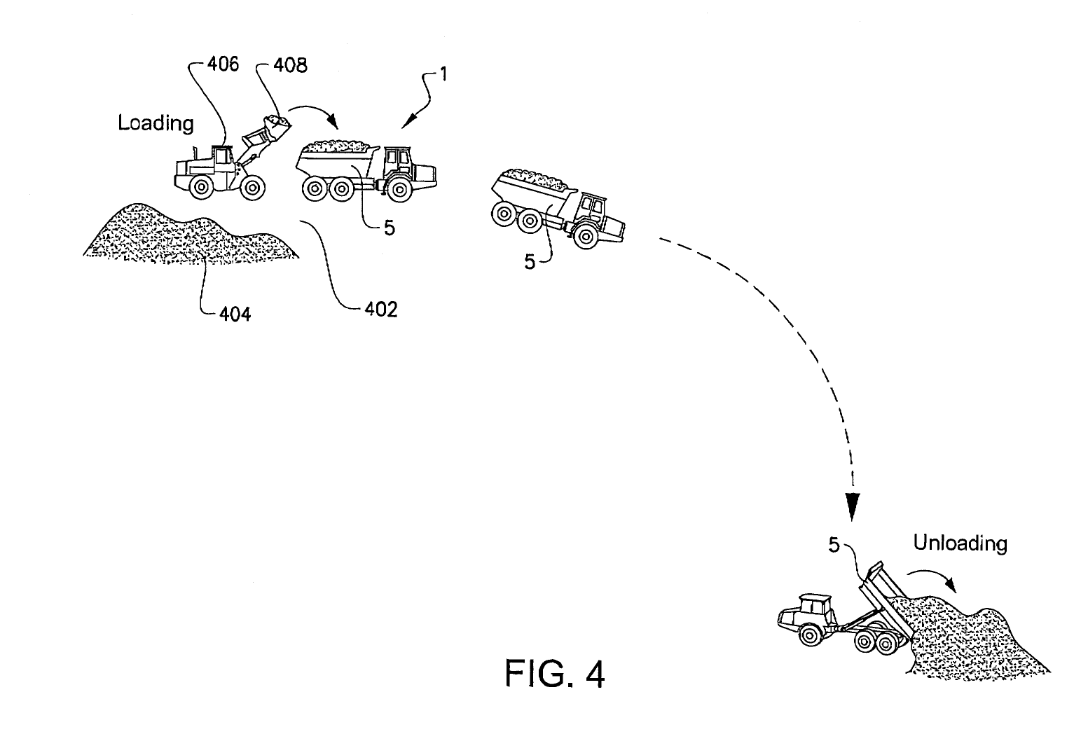

Furthermore, the working machine 1 in the illustrated embodiment of FIG. 1 is provided with a control system 200 (see FIG. 2) which comprises a control unit 202 connected to at least one weight indication means 204. The weight indication means 204 is in FIG. 1 illustrated as a weight sensor. The weight indication means 204 is arranged in connection to the platform of the vehicle for measuring a load of the platform. Hence, the at least one weight indication means 204 is arranged to measure a load which is being supplied to, in the example embodiment depicted in FIG. 1, the dump body or container 5 arranged on the platform. Furthermore, the control unit 202 is also connected to an engine control system 206, in FIG. 1 illustrated as incorporated in the vehicle engine. The control unit 202 and its associated components, as well as the corresponding method for controlling the engine of the vehicle, are described in further detail below with reference to FIGS. 2-4. More specifically, an example embodiment of the control system 200 will be described in relation to FIG. 2, the method of controlling the engine of the vehicle according to an example embodiment will be described in relation to FIG. 3, and a loading scenario where the working machine is provided with the inventive control unit 202 will be described in relation to FIG. 4.

In FIG. 2, an example embodiment of the control system 200 according to the present invention is depicted. The control system 200 comprises a control unit 202 which is connected to an engine system 206 of the vehicle 1. The engine system 206 is in turn connected to the engine of the vehicle for e.g. starting/stopping the vehicle engine, etc. Moreover, the control unit 202 in FIG. 2 is further connected to a weight indication means 204 arranged in connection to the platform of the vehicle, a gear box position arrangement 208, driving seat sensor(s) 210, a vehicle load starting actuator 212, and vehicle stand-still determination means 214. It should however be readily understood that the control unit 202 may also be connected to other vehicle “surveillance” systems which will be described further below. Also, the invention should not be construed as limited to a control unit 202 which is connected to all of the different parts described, which are mainly included in the description for illustrative purposes and for simplified understanding of the invention and its alternatives.

The weight indication means 204 is, as described above, connected to the platform of the vehicle 1. Hereby, the weight indication means 204 receives a measured weight of the load on the platform. The measured weight may be continuously provided to the control unit 202 such that the control unit 202 continuously receives input from the weight indication means 204 regarding the instantaneous weight of the load on the platform. The invention is not limited to a specific number of weight indication means in connection to the platform. The number of weight indication means is of course dependent on the specific application, such as the size of the vehicle, the need of accuracy, etc.

Furthermore, the weight indication means 204 may be connected to an on board weighing system of the vehicle. The on board weighing system monitors the input of weight from the weight indication means 204 and provides this information to vehicle electronics such that the weight of the load on the platform can be provided to e.g. a display arrangement in the instrument panel of the vehicle cabin.

Moreover, the gear box position arrangement 208 is configured to determine the instantaneous driving gear of the vehicle 1. Hence, the gear box position arrangement 208 determines whether e.g. the gear box is in neutral position, or, if it is an automatic gear box transmission, if the gear box is in a drive position. A signal relating to the determination of the gear box position is configured to be provided to the control unit 202.

Furthermore, the driving seat sensor(s) 210 is/are arranged in connection to a driving seat of the vehicle. The driving seat sensor 210 is in the following referred to in singular as a driving seat sensor. More particularly, the driving seat sensor is preferably a weight or pressure sensor which is configured to sense the presence of a driver sitting in the driving seat. Hence, the driving seat sensor 210 will continuously receive a measured weight on the driving seat of the vehicle and provide a signal relating to the measured/detected weight to the control unit 202.

Still further, the vehicle load starting actuator 212 is an arrangement that provides an indication that the vehicle is arranged to receive a load. More specifically, when the vehicle load starting actuator 212 is activated, a signal is provided from the vehicle load starting actuator 212 to the control unit 202 indicating that the vehicle is about to receive a load. The vehicle load starting actuator 212 may further be connected to the gear box position arrangement 208 such that when the vehicle load starting actuator 212 is activated, a signal is provided to the gear box position arrangement 208, either directly or via the control unit 202, for arranging the gear box in neutral position. When the vehicle load starting actuator is activated, a signal may also be provided for applying the brakes of the vehicle.

Furthermore, the vehicle load starting actuator 212 may be a maneuvering organ (not shown), or connected to a maneuvering organ, which is connected to the control unit and that, when being activated, activates the brakes of the vehicle and positions the gear box in neutral position. Hereby, when the maneuvering organ is activated, the vehicle is in a stand-still configuration and determined to be in the load receiving mode.

Finally, the vehicle stand-still determination means 214 is arranged to determine if the vehicle is arranged in a stand-still configuration. In detail, if the vehicle is arranged in the stand-still configuration, the vehicle is not able to move if e.g. the vehicle engine is started. This may, for example, be determined by means of checking/verifying that the gear box is in neutral position or that the brakes are applied, etc. Hence, the vehicle stand-still determination means 214 may be connected to e.g. the gear box position arrangement 208, a brake control system (not shown), etc. However, the vehicle stand-still determination means may also be connected to e.g. cameras of the vehicle, or other sensing means, which determines that, for example, the vehicle is standing on a flat surface such that the vehicle will not move when/if the vehicle engine is started.

Now, in order to describe the functionality of the control system 200, or more particularly the control unit 202 depicted in FIG. 2, attention is drawn to FIG. 2 in combination with FIG. 3.

When the vehicle 1 has arrived at a loading position to receive a load, the weight indication means 204 detects a weight of the platform. The detected weight of the platform is provided to the control unit 202. Hence the control unit 202 receives S1 a weight of the load on the platform. The control unit 202 compares S2 the received weight from the weight indication means 204 with a predetermined threshold value. The predetermined threshold value can be set differently depending on e.g. the specific loading condition, the size of the vehicle being provided with a load, the size of the bucket providing the load to the vehicle, etc. The predetermined threshold value should preferably be a value which is lower than the weight of the platform when fully loaded. If, for example, the size of the bucket loading the container of the vehicle is such that it will take four loadings until the container is full, the predetermined threshold value may be set to the weight of three loads from the bucket. The loading of the container may in some applications be provided from a crusher continuously providing the container 5 with load. The predetermined threshold value may in such situation be set to a weight which is slightly below the weight of a fully loaded container and which also takes the time aspect until the container is fully loaded into consideration.

Thereafter, it is determined S3 if the weight is above the predetermined threshold value or not. If the weight of the platform is below the predetermined threshold value, the procedure is restarted and the control unit 202 receives S1 a new weight value from the weight indication means 204. It should be understood that the step of comparing S2 the weight with the predetermined threshold value and the step of determining S3 if the weight is above the predetermined threshold value can be executed in one and the same step and does hence not have to be provided in the illustrated executive order.

If, on the other hand, the weight of the load on the platform is above the predetermined threshold value, an engine start-up signal is provided S4 to the engine system 206 described above. Hereby, if the weight of the load on the platform has exceeded the predetermined threshold value, the vehicle engine is started.

Accordingly, and with reference to the above example, the vehicle engine will be initiating start-up once the dump body or container 5 has received three loads from the bucket. When the fourth load from the bucket is received, the vehicle engine is fully started, the container 5 is fully loaded, and the vehicle can thus take off to e.g. the unloading position.

However, before providing S4 the engine start-up signal to the engine system 206 of the vehicle 1, other steps, which are indicated in FIG. 3, may be executed in order to increase the safety of the inventive method. For example, after it has been determined S3 that the weight of the load on the platform is above the predetermined threshold value, it may be determined S5 if the vehicle is in a load receiving mode. The load receiving mode can be a safety arrangement which is provided in order to execute the method under certain circumstances. Examples of load receiving modes may be that the operator of the vehicle has activated the above described vehicle load starting actuator 212 or that the driving seat sensor 210 indicates that the driver is sitting in the driving seat of the vehicle, etc. Another load receiving mode may be that the weight indication means measures a substantially continuous increase of the load during a predetermined time period. Hereby, it is determined that the method will only continue if the vehicle is in a state of loading. Determining if the vehicle is in a load receiving mode is advantageous since it will enable the method to be executed only when desired. For example, if the weight of the load on the platform is above the predetermined threshold and the operator of the vehicle has turned off its engine for some reason other than for loading the platform, a start-up signal will not be provided to the engine system. Hence, if it is determined that the vehicle is not in the load receiving mode, the method is either ended S7 or a new determination is made whether the vehicle is in the load receiving mode or not.

If it is determined S5 that the vehicle 1 is in the load receiving mode, it is determined S6 if the vehicle 1 is in a stand-still configuration, by means of the vehicle stand-still determination means 21 as described above. Hereby, it is assured that the vehicle will be kept in a stand-still position even if the vehicle engine is started. If it is determined that the vehicle is not in a stand-still configuration, the method is ended S7 or a new determination is made whether the vehicle is in a stand-still configuration or not. If it is determined that the vehicle is in a stand-still configuration, the engine start-up signal is provided S4 to the engine system 206.

Moreover, other steps can also be provided to the inventive method for even further securing that the engine start-up signal is provided to the engine system only when it is desirable to do so. Furthermore, the steps described in relation to FIG. 3 should not be construed as limited to the above described consecutive order. For example, the steps of determining S5 if the vehicle is in the load receiving mode or determining S6 if the vehicle is in the stand-still configuration may be executed before comparing S2 the weight with the predetermined threshold value. In fact, the steps S5 and S6 may be executed even before receiving S1 a weight of the platform. Hereby, the method does not need to be executed at all if it is determined that the vehicle is not in a load receiving mode or is not in a stand-still configuration.

Still further, the invention should not be construed as limited to include the above describe safety steps of determining S5 if the vehicle is in the load receiving mode or determining S6 if the vehicle is in the stand-still configuration, the invention works equally as well without these steps, or provided with only one of the steps.

Finally, in order to further describe the functionality of the present invention, reference is made to FIG. 4 which illustrates a loading scenario at a working site where the vehicle is provided with the inventive control unit according to an example embodiment of the present invention.

At first, the vehicle arrives at the loading position 402. The operator of the vehicle 1 can activate the above described maneuvering organ such that the gear box is arranged in neutral gear position and the brakes of the vehicle are activated. Hereby, the vehicle is arranged in the load receiving mode and in the stand still configuration.

Hence, the vehicle 1, herein an articulated hauler, is standing at the loading position 402 and arranged to receive a load 404. The load 404 is provided to the dump body or container 5 of the vehicle 1 by means of a wheel loader 406 or the like. More particularly, the load is provided to the container 5 of the vehicle 1 from a bucket 408 of the wheel loader 406.

When the bucket 408 provides the load 406 to the container 5, the weight indication means 204 measures the weight of the load on the platform. When the bucket 408 has provided a sufficient amount of loads to the container 5, it is determined that the weight of the load on the platform has exceeded, and is thus above, the predetermined threshold value. Hereby, an engine start-up signal is provided to the engine system 206 of the vehicle such that the vehicle engine is started. At the same time, i.e. during the period of starting up the vehicle engine, the wheel loader 406 continues to provide load to the container of the vehicle since the container 5 has not yet been filled up to its total desired weight. Thereafter, the vehicle engine is fully started and the loading of the container is finished. The vehicle 1 can thus start driving to the unloading position where it shall unload the load of the container. At the unloading position, the operator of the vehicle may again activate the maneuvering organ, such that the gearbox is positioned in neutral gear position and the brakes of the vehicle are activate.

It is to be understood that the present invention is not limited to the embodiments described above and illustrated in the drawings; rather, the skilled person will recognize that many changes and modifications may be made within the scope of the appended claims.

1. A control unit for controlling a vehicle comprising a platform for carrying a load and an engine system for controlling an engine of the vehicle, wherein the control unit is configured to receive a signal, from at least one weight indication means of the vehicle, the signal being indicative of a weight of a load on the platform; compare the received indicated weight of the load on the platform with a predetermined threshold value;
wherein the control unit is further configured to provide an engine start-up signal to the engine system of the vehicle if the received indicated weight of the load on the platform is above the predetermined threshold value.

2. The control unit according to claim 1, further configured to determine if the vehicle is in a load receiving mode; and to provide the engine start-up signal to the engine system only if the vehicle is in the load receiving mode.

3. The control unit according to claim 2, wherein the vehicle is in the load receiving mode if the signal received from the at least one weight indication means indicates an increase of the load on the platform within a predetermined time period.

4. The control unit according to claim 2, further configured to receive a signal from a load starting actuator, indicating that the vehicle is in the load receiving mode.

5. The control unit according to claim 1, further configured to receive a signal from a vehicle stand-still determination means indicative of a vehicle stand-still configuration; and to provide the engine start-up signal to the engine system only if the received signal from the vehicle stand-still determination means indicates that the vehicle is arranged in a stand-still configuration.

6. The control unit according to claim 1, further configured to receive a signal from a driving seat sensor configured to sense the presence of a driver in the vehicle driving seat; and to provide the engine start-up signal to the engine system only if the received signal from the driving seat sensor indicates that the driver is sitting in the driving seat of the vehicle.

7. The control unit according to claim 1, further configured to receive a signal indicative of a current gear position of a gearbox of the vehicle; and to provide the engine start-up signal to the engine system only if the gearbox of the vehicle is arranged in neutral gear position.

8. The control unit according to claim 1, further configured to determine if the vehicle is in a load receiving mode; and to provide an engine shut-down signal to the engine system if the vehicle engine is running and the received indicated weight of the load on the platform is below the predetermined threshold value.

9. The control unit according to claim 1, wherein the predetermined threshold value is configured to be manually set before the platform receives the load.

10. The control unit according to claim 1, wherein the predetermined threshold value is a first predetermined threshold value, wherein the control unit comprises further predetermined threshold values for additional loading of the platform.

11. A method for controlling a vehicle comprising a platform for carrying a load and an engine system for controlling an engine of the vehicle, the method comprising the steps of:
receiving a signal, from at least one weight indication means of the vehicle, indicative of a weight of a load on the platform;
comparing the received indicated weight of the load on the platform with a predetermined threshold value; and
providing, from a control unit, an engine start-up signal to the engine system of the vehicle if the received indicated weight of the load on the platform is above the predetermined threshold value.

12. A control system for controlling a vehicle comprising a platform for carrying a load, the control system comprising a weight indication means for detecting a weight of a load on the platform, an engine system for controlling an engine of the vehicle, and a control unit; wherein the control unit is configured to receive a signal from the weight indication means, the signal being indicative of the detected weight of the load on the platform; compare the received indicated weight of the load on the platform with a predetermined threshold value;
wherein the control unit is further configured to provide an engine start-up signal to the engine system if the received indicated weight of the load on the platform is above the predetermined threshold value.

13. A computer comprising a computer program for performing the method according to claim 11 when the program is run on the computer.

14. A non-transitory computer readable medium carrying a computer program for performing the method according to claim 11 when the program product is run on a computer.

15. A vehicle comprising a platform for carrying a load and an engine system for controlling an engine of the vehicle, wherein the vehicle is provided with a control unit according to claim 1.
